(19) United States
(12) Patent Application Publication
(10) Pub. No.: US 2009/0157635 A1
(43) Pub. Date: Jun. 18, 2009

(54) SYSTEM AND METHOD FOR USING UNIVERSAL LOCATION REFERENCING OBJECTS TO PROVIDE GEOGRAPHIC INFORMATION

(75) Inventors: Gil Fuchs, Woodside, CA (US); Ettie Ettinger, Laguna Beach, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/344,146

(22) Filed: Dec. 24, 2008

Related U.S. Application Data
(63) Continuation-in-part of application No. 11/271,436, filed on Nov. 10, 2005.
Application No. 11/271,436 is a continuation-in-part of application No. 11/742,937, filed on May 1, 2007.

(51) Int. Cl. G06F 7/06; G06F 17/30

(52) U.S. Cl. 707/3; 707/103 Y; 707/103 Z; 707/E17.014; 707/E17.018; 707/E17.055

(57) ABSTRACT

A system and method for using universal location referencing objects (ULRO) to provide geographic information. As described herein, an embodiment of a ULRO comprises a permanent identification code designed to identify a selected location. A location in turn may be associated with one or more geographic items. A ULRO can be employed to establish traversable links or connections between a file-of-reference and third-party-files for a broad range of database formats. A file-of-reference is a geospatial file used for permanent storage of a file owner's geographic data. A third-party-file is a geospatial file used for permanent storage of a third-party's geographic data. Whatever its format may happen to be, a file-of-reference or a third-party-file can typically be transformed into other formats that may be more appropriate for certain applications. In accordance with various embodiments of the present invention, this technique can be used to establish traversable links between a map-of-reference and one or more of third-party maps and third-party-spatial data files.

This application is a continuation-in-part of copending U.S. Patent Applications “METHOD AND SYSTEM FOR CREATING UNIVERSAL LOCATION REFERENCING OBJECTS”, application Ser. No. 11/271,436, filed Nov. 10, 2005; and “SYSTEM AND METHOD FOR PROVIDING A VIRTUAL DATABASE ENVIRONMENT AND GENERATING DIGITAL MAP INFORMATION”, application Ser. No. 11/742,937, filed May 1, 2007, each of which applications are herein incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF INVENTION

The invention is generally related to electronic maps, electronic documents, and electronic databases, and particularly to a system and method for using universal location referencing objects to provide geographic information.

### BACKGROUND

Paper maps have been largely superceded by databases, documents, and maps in digital, electronic formats, capable of being updated as desired and able to respond to a selected range and type of operator input and to produce operator-requested output. Many electronic documents and electronic databases in common usage today comprise information related to geographic location(s). Examples of electronic databases include geospatial databases, commonly referred to as electronic maps or digital maps. Today, maps have evolved well beyond their centuries-old status as static paper depictions of a non-adjustable data set as recorded at one particular time. For simplicity, much of the discussion below refers to electronic maps, although the points made also apply to electronic documents and electronic databases, other than maps, that contain geographic information.

Digital maps are often used in commercial environments, for example, in calculating optimized routes for delivery drivers to take when performing deliveries, for providing accurate directions for emergency and medical crews to follow when responding to emergency calls, and military applications. Digital maps find a use in all aspects of industry, including for ground-based, maritime, and aviation purposes. As people have become more familiar with portable, handheld electronic devices such as Personal Digital Assistants (PDA's) and smart phones, which are increasingly distributed together with electronic maps stored therein, the electronic or digital map industry has grown to infiltrate virtually every aspect of society.

Many traditional digital maps use map-level overlays, meaning that they are registered one to another on the basis of their coordinates. Little or no interactivity is typically available between different points in the overlay or between a point in one overlay and a point in another overlay. While such a coordinate overlay may result in something that appears to an end-user like a single map, it cannot dynamically function like one fully integrated, intelligent digital map. In a sense, the entities in one layer know nothing about the entities in any other layer and hence cannot support further data processing related to useful linkages between those entities. Moreover, such an overlay map is only possible if it is permitted by the scales, formats and coordinate systems of the different maps and different spatial data files. Such an overlay map is not feasible if the information in one or more of the documents is not already presented in the form of a compatible map.

A richer set of linkages can be provided if all of the information has been comprised within a single integrated map file. This puts the burden on a single map vendor to integrate the entire body of spatial knowledge into a single electronic map. However, in most situations, the map vendor does not even have access to all the necessary information, so despite their best intentions, it is increasingly difficult to create a completely integrated map. These are the general areas that embodiments of the invention are designed to address.

### SUMMARY

Described herein is a system and method for using universal location referencing objects (ULRO) to provide geographic information. As described herein, an embodiment of a ULRO comprises a permanent identification code designed to identify a selected location. A location in turn may be associated with one or more geographic items. A ULRO can be employed to establish traversable links or connections between a file-of-reference and third-party-files for a broad range of database formats. A file-of-reference is a geospatial file used for permanent storage of a file owner's geographic data. A third-party-file is a geospatial file used for permanent storage of a third-party's geographic data. Whatever its format may happen to be, a file-of-reference or a third-party-file can typically be transformed into other formats that may be more appropriate for certain applications. In accordance with various embodiments of the present invention, this technique can be used to establish traversable links between a map-of-reference and one or more of third-party maps and third-party-spatial data files. These and other objectives, advantages, and benefits of embodiments of the present invention will be evident from the accompanying detailed description and drawings.

### BRIEF DESCRIPTION OF THE DRAWINGS

FIG. 1 is an illustration that depicts the assignment of ULRO to locations in an electronic file-of-reference, in accordance with an embodiment.

FIG. 2 is an illustration that depicts a ULRO corresponding to a selected geographic item associated with a location, in accordance with an embodiment.

FIG. 3 is an illustration of a system for using ULRO with offset pointers, in accordance with an embodiment.

FIG. 4 is an illustration of a system for using ULRO with interchangeable file-of-reference and third-party-files, in accordance with an embodiment.

FIG. 5 is another illustration of a system for using ULRO with interchangeable file-of-reference and third-party-files, showing how the ULRO is modified, in accordance with an embodiment.

FIG. 6 is an illustration of a system for using ULRO with cascading of ULRO information, in accordance with an embodiment.

FIG. 7 is another illustration of a system for using ULRO with cascading of ULRO information, showing the result of cascading in accordance with an embodiment, and from the perspective of the file-of-reference.

FIG. 8 is an illustration of a system for using ULRO with cascading of ULRO information, showing how the ULRO is modified, in accordance with an embodiment.

FIG. 9 is a diagram that schematically illustrates an example of a system that can be used with different embodiments.

### DETAILED DESCRIPTION

Described herein is a system and method for using universal location referencing objects (ULRO) to provide geographic information. As described herein, an embodiment of a ULRO comprises a permanent identification code designed to identify a selected location. A location in turn may be associated with one or more geographic items. A ULRO can be employed to establish traversable links or connections between a file-of-reference and third-party-files for a broad range of database formats. A file-of-reference is a geospatial file used for permanent storage of a file owner's geographic data. A third-party-file is a geospatial file used for permanent storage of a third-party's geographic data. Whatever its format may happen to be, a file-of-reference or a third-party-file can typically be transformed into other formats that may be more appropriate for certain applications. In accordance with various embodiments of the present invention, this technique can be used to establish traversable links between a map-of-reference and one or more of third-party maps and third-party-spatial data files.

As further described herein, in accordance with an embodiment a ULRO points to geographic items associated with a common location and located in two or more different files. Often but not always, one of the files is the database-of-reference. Effectively, a traversable link is thereby created between the two files. Using the example of map containing restaurant information, and text entries, using the ULRO approach additional attributes can be integrated and presented to a user regardless of whether the information is contained in the form of a map or in another form. For example, if the restaurant information is a text listing of restaurant names, it can be combined with the railroad and street maps to create a virtual map as easily and effectively as if the restaurant information was in map format. Through the use of ULRO, it is easier for operators of end-user applications to obtain spatially relevant data from virtual maps. Virtual maps are capable of using the present invention to usefully and accessibly combine the information in a file-of-reference with information comprised in one or more of a variety of third-party sources. ULRO may also be used together with virtual map database techniques to create virtual maps in a dynamic, run-time fashion.

In accordance with an embodiment, a system and method for using ULRO with offset pointers is provided. In such embodiments, offset pointer addressing allows the system to provide information for locations for which either no current object exists in the file-of-reference, or, as described above, the position of the third-party information does not coincide with the position of a feature in the digital map database. In accordance with an embodiment, instead of specifying a pointer to the geographic item in the file-of-reference or third-party-file, the system can specify a pointer to another geographic item in the file, together with an appropriate offset

In accordance with an embodiment, a system and method for using ULRO with interchangeable file-of-reference and third-party-files is provided. Depending on the embodiment, the sharing of data between the file-of-reference and the third-party-files can be performed on an ongoing basis as a background process, as a one-time batched or periodic process, in a dynamic real-time fashion to respond to a request, or by either the digital map provider or one or more third-party data providers pushing and/or pulling map information from one party to another so as to share the data. Generally, the sharing of information is more efficiently handled as a series of scheduled updates, which can be performed at less busy times, rather than on a per-request basis, and can be initiated either by the system that is hosting the file-of-reference, or, as described in further detail below, by any of the other third-party systems that provide access to the ULRO. In those embodiments that are request-driven, the request can be received via an application program interface (API) either by the system that is hosting the file-of-reference, or by any of the other third-party systems that provide access to the ULRO.

In accordance with an embodiment, ULROs can be stored in a ULRO repository under control of the digital map provider, and/or stored together with the file-of-reference at the digital map provider location. The ULRO repository can provide an API that allows information to be shared with third-parties, and in some embodiments allows requests for information to be received from users and other systems. In some embodiments an API allows for automatic or batched pushing and pulling of ULRO-related information between different parties. As described herein, a party can be a company or organization, or can be an individual person, or a mobile device or other source of data.

In accordance with an embodiment, a system and method for using ULRO with cascading of ULRO information is provided. In such embodiments, each party can maintain its own ULRO pattern, which defines that particular party's understanding of ULRO pointers and the geographic item information linked thereto. Pointers can be interpreted by a third-party to map to a different ULRO pattern. In some instances a third-party can maintain its own repository of ULRO that are private or otherwise not directly accessible by the other third-parties. This linkage can be continued indefinitely over many third-parties in a domino-like or cascading manner. The different ULROs can be traversed, again in a cascading manner, taking into account the different ULRO patterns, and any access rights that may have been applied to private ULRO, to share information between the ULRO and the third-parties. This cascading can be performed as an ongoing background process, as a one-time batched or periodic process, or in some embodiments in a dynamic real-time fashion to respond to a request. This feature can also be used in a VDB environment to provide for more universal provisioning of data in real-time across many third-parties, and many disparate data sources that use a different data format. In accordance with an embodiment, the system can be used to provide results in response to a search by a user. For example the system can provide information from a third-party-file including specifying a pointer to a geographic item in the file-of-reference, and providing an appropriate offset by which the third-party information can be related; or can provide referencing of geographic information either by the system that is hosting a file-of-reference, or by any of other third-party-file systems; or can cascade links to the additional geographic item information in third-party-files, upon receiving a search request from the user, and then providing information as a response to the request.

The following terms are used throughout this document, and are also described in copending U.S. Patent Applications “METHOD AND SYSTEM FOR CREATING UNIVERSAL LOCATION REFERENCING OBJECTS”, application Ser. No. 11/271,436, filed Nov. 10, 2005; and “SYSTEM AND METHOD FOR PROVIDING A VIRTUAL DATABASE ENVIRONMENT AND GENERATING DIGITAL MAP INFORMATION”, application Ser. No. 11/742,937, filed May 1, 2007, each of which applications are herein incorporated by reference:

Feature—A geographic feature is an idealized map representation of an actual object from the real world, which is useful to that map representation.

Dimension of Feature—Features are often represented in the map model in a more simple way than in their full “real world” complexity; thus, the dimension of a feature does not reflect the real world truth, but rather what the representation has rendered.

Type of Feature and Class of Feature—Types and classes are subcategories of features that enable them to be distinguished.

Geometry of Feature—In the computer map model, features often have a geometrical representation of the feature's shape.

Topology—Topology is a set of mathematical properties that are used as a means of capturing connectivity relationships between features which remain true even when the geometry (shape) of the feature might undergo some change.

Simple Feature—Point features, line feature, area features, and volume features are simple features, since they are directly modeled by assigning geometrical shapes to them.

Complex Feature—Conversely, complex features may be indirectly defined by other features (simple or complex), as well as by direct geometrical rendering.

Plurality of Features—Both the simple and complex features described above are examples of single features; however, it is sometimes useful to think about several features at once, hence creating a plurality of features.

Sub-Set of Feature—It is sometimes convenient to identify a portion, sub-set, or a part of a single feature.

Attribute—Features, plurality of features, and sub-sets of features may have attributes. Attributes are provided in large catalogs, and there may be thousands of different attributes applying to features in a commercial computer map model of the real world.

Relationship—Relationships are comprised of two or more features “participating” in some meaningful connection to each other.

Geographic item—For the purpose of this description, a non-ISO standard term is employed here. A geographic item is defined here to be either a feature, a plurality of features, a sub-set of a feature, or an attribute.

Location—The location where a feature is in the real world is distinct from the feature itself. For example, while the feature may be the restaurant, its location can be specified as some latitude, longitude (lat/long) coordinate pair, or coordinates from some similar geodetic referencing system, or as a human readable address.

Hierarchy of features—Features often form a hierarchy of construction.

Point of interest—A point of interest (POI) is a special type of point feature, in particular it is a type that may comprise other more specific types, such as a restaurant, hotel, or museum.

In accordance with an embodiment, a ULRO comprises a permanent identification code and sufficient information designed to uniquely identify a selected location. A location, in turn, may be associated with one or more geographic items. ULROs can be employed to establish traversable links between a file-of-reference and one or a plurality of third-party-files for a broad range of database formats. ULROs can be similarly employed to establish traversable links between two or more third-party-files.

A file-of-reference is a geospatial database used for permanent storage of a document owner's geographic data. A file-of-reference can typically be transformed into other formats that may be more appropriate for certain applications. In accordance with an embodiment there is only one file-of-reference database identified to support ULROs. A third-party-file is any file that contains some element of spatial data, which may consist of geographic features, attributes of features or relationships of two or more features. A third-party-file is distinct from the file-of-reference.

ULROs uniquely correspond to a particular location. A document need not be a map in order to comprise a geographic item that is associated with a location. ULROs can be easily updated as information changes and as more precise information is obtained. ULROs point to geographic items in two or more different files that are associated with the same location, so that a traversable link or connection is effectively created between the two files. ULROs are not required in order to create traversable links between different documents comprising geographic information. ULROs do, however, substantially reduce the number of connections required to create traversable links between each of a set, N, of geographic items.

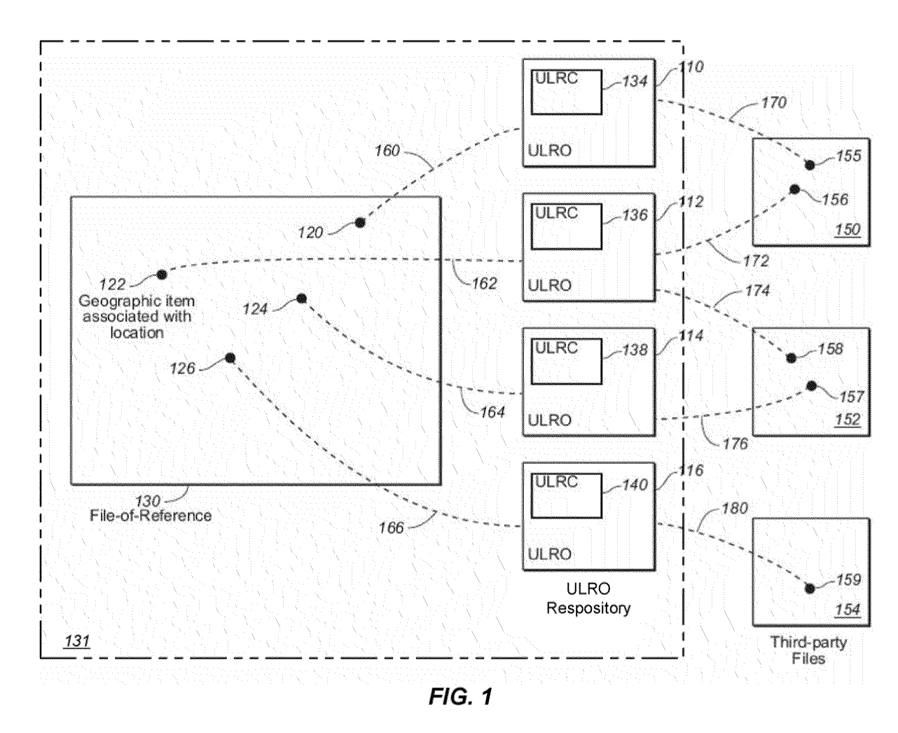

FIG. 1 is an illustration that depicts the assignment of ULRO comprising permanent ID codes, to geographic items associated with locations in an electronic file-of-reference, in accordance with an embodiment. As shown in FIG. 1, ULROs are assigned to geographic items associated with a location 120, 122, 124, 126 in an electronic file-of-reference 130 to form a ULRO-based system 131. In keeping with the definition provided above, the geographic items can be any of a feature, a plurality of features, a sub-set of features, or an attribute associated with a physical location, so that in FIG. 1 the geographic items 120, 122, 124, 126 may in actuality be associated with a single physical location. Each of ULROs 110, 112, 114, 116 comprise respectively a universal location referencing code (ULRC) 134, 136, 138, 140. In accordance with an embodiment each ULRC may in turn comprise a permanent identifier or permanent ID. The ULRO can be easily and accurately maintained and updated, generally within a ULRO repository, and can be used to link the geographic items associated with locations in the file-of-reference with corresponding location information 155, 156, 157, 158, 159 in one or more third-party-files 150, 152, 154. As shown in FIG. 1, a single geographic item associated with a location, for example location 120, may be linked to a single ULRO 110 that links to a single third-party-file 150. Alternatively, a single geographic item associated with a location, for example location 122 may be linked to a single ULRO 112 that links to a plurality of third-party-files 150, 152.

The use of ULRO hierarchies, and ULRO groups, both of which are described in further detail below, allows other types of linking, so that almost any combination of file-of-reference and third-party-file is possible. Furthermore, links 160, 162, 164, 166, 170, 172, 174, 176, 180 can be either uni-directional pointers, bi-directional pointers, or a mix of both uni- and bi- directional pointers. This feature provides that, while in FIG. 1, the file-of-reference 130 appears as a base map, it is also possible to treat any of the third-party-files equally as the file-of-reference, and for the locations therein to be similarly linked to information in the other files. The bi-directional nature of the ULRO mapping allows any third-party-file to act as the file-of-reference, and allows the file-of-reference to act as a third-party-file, depending on the particular application.

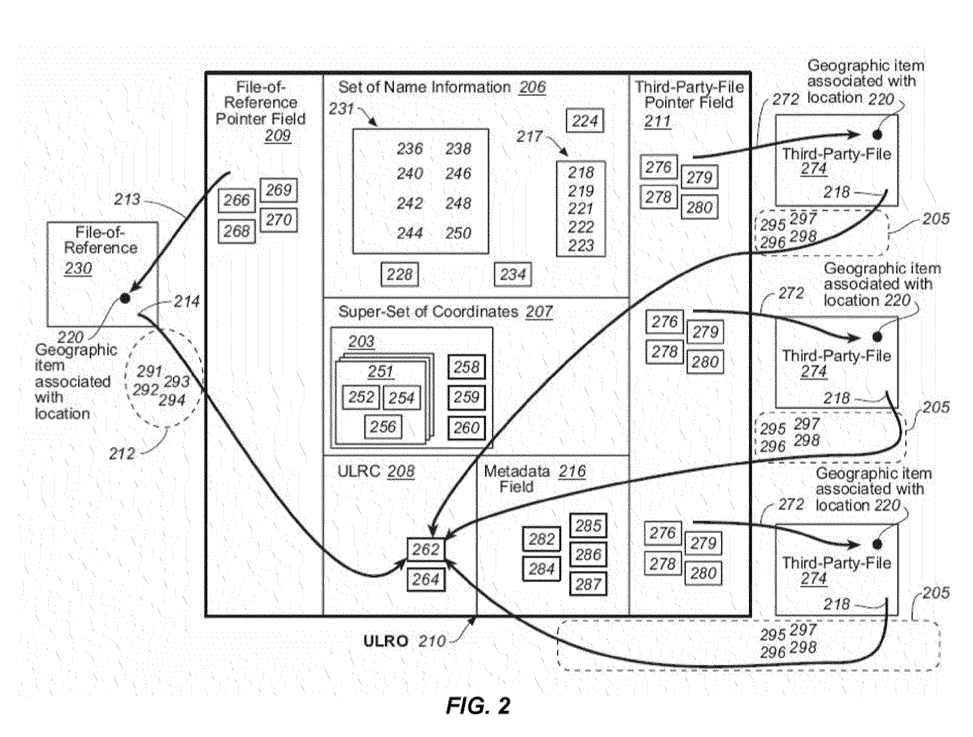

FIG. 2 is an illustration that depicts an environment including a ULRO corresponding to a selected geographic item associated with a location in a file-of-reference, in accordance with an embodiment. Some of the features shown in FIG. 2 are optional, and may not be used for each instance of the ULRO. As shown in FIG. 2 the ULRO 210 allows for mapping of location-related information between an electronic file-of-reference 230, and one or a plurality of third-party-files 274, each of which files comprising one or more geographic items associated with a location 220, together with associated pointers and information linking the files. As described above, the only mandatory field in the ULRO is the ULRC 208. It is also mandatory that the set of name information and the set of coordinates not both be blank, although either one of these fields can be blank for a particular ULRO.

As shown in FIG. 2, in accordance with an embodiment, the ULRO logically resides in three places within the ULRO environment. The bulk of the ULRO can reside almost anywhere, such as within a file on a server connected to the Internet. The complete ULRO also includes other components, (i.e. back-pointers), that are physically associated with the file-of-reference 230, and with the third-party-files 274 respectively. In accordance with an embodiment, the ULRO 210 comprises a set of name information 206, a coordinate super-set 207, a ULRC 208, a file-of-reference pointer field 209, a third-party-file pointer field 211, a file-of-reference back-pointer field 212; a third-party-file back-pointer field 205; and a metadata field 216.

In accordance with an embodiment, the set of name information 206 comprises one or more of the following: 1) an address 217, which in turn comprises one or more of the following: 1a) a postal code 218, 1b) a street number 219, 1c) a street name 221; 1d) a hierarchical area address system with a sequence of names 222; and 1e) other address information 223; 2) a named place 224; 3) a telephone number 228; 4) geographic name information 231; and 5) other name information 234. In accordance with an embodiment, the geographic name information 231 comprises one or more of the following: 4a) name information for a point feature 236; 4b) name information for a line feature 238; 4c) name information for an area feature 240; 4d) name information for a volume feature 242; 4e) name information for a segment of a line feature 244; 4f) name information for a sector of an area feature 246; 4g) name information for a section of a volume feature 248; and 4h) name information for a plurality of related geographic items 250.

In accordance with an embodiment, the ULRO comprises one, or a plurality, k, of coordinate super-sets 207, wherein k is the number of coordinate super-sets comprised in the physical location that is in turn associated with the geographic item 220. For clarity, in the example shown in FIG. 2, a single coordinate super-set 203 is illustrated, but a ULRO could comprise one, two, or more coordinate super-sets. Each coordinate super-set 203 comprises k geographic coordinate sets 251. The geographic coordinate set 251 in turn comprises geographic coordinates, such as a latitude 252 and a longitude 254, and may also comprise an elevation 256. In accordance with an embodiment, the coordinate super-set 203 also comprises a coordinate classification 258 and other coordinate information 260. Optionally, information relating to a linear referencing system 259, such as those used in conjunction with major motorways or cell phone towers, can be included. This may, for example, include information relating to a cellular phone network associated with the location 220. This allows the system to use cell phone towers or linear referencing schemes or a combination of any of these instead of geographic coordinates, or alternatively the system can use a combination of both geographic and cell phone coordinates. In other embodiments, the coordinate super-set can be assigned with reference to a transportation network such as a railway system or a highway linear referencing system.

As described above, the ULRC 208 uniquely corresponds to the location. In accordance with an embodiment, the ULRC 208 comprises an identification code 262. The ULRC 208 may also comprise other ULRC information 264.

In accordance with an embodiment, the file-of-reference pointer field 209 comprises, when appropriate, a file-of-reference pointer 213 that designates said location 220 in said file-of-reference 230. Each file-of-reference pointer 213 may further comprise one or more of the following: a time of creation 266 of the file-of-reference pointer; information 268 identifying a type and class 269 of the file-of-reference pointer field, and other file-of-reference pointer field information 270.

In accordance with an embodiment, the third-party-file pointer field 211 comprises one or more third-party-file pointers 272, each of which uniquely designates one or more said location-associated item(s) 220 in one of said one or more third-party-files 274. The number of third-party-file pointers 272 pertaining to a particular one geographic item associated with a location 220 equals the total number of associations within those third-party-files 274 that comprises the geographic item associated with the location 220. For any particular third-party-file, there may be either one, or more than one association within each file. Assuming that each third-party-file will usually provide at least some information for the geographic item associated with the location, then the total number of third-party pointers will typically be at least equal to the number of third-party-files, but will often be greater by the number of additional associations. Each third-party-file pointer 272 may further comprise one or more of the following: a time of creation 276 of the third-party-file pointer, a type 278, and class 279 of the third-party-file pointer, and other third-party-file pointer field information 280.

In accordance with an embodiment, the file-of-reference back-pointer field 212 comprises a file-of-reference back-pointer 214 pointing from the file-of-reference 230 back to said central component of said ULRO 210, and more specifically back to the ULRC code, 262. The file-of-reference back-pointer, while a part of the logical ULRO, is resident in the file-of-reference and is there to facilitate the two way traversal between data items. Each file-of-reference back-pointer 214 may further comprise one or more of the following: a time of creation 291 of the file-of-reference back-pointer; a type 292 and class 293 of the file-of-reference back-pointer; and other file-of-reference back-pointer information 294.

In accordance with an embodiment, the third-party-file back-pointer field 205 comprises one or more third-party-file back-pointers 218, wherein each third-party-file back-pointer 218 uniquely points from one of the third-party-files 274 back to the ULRO 210, and more specifically back to the ULRC code 262. The third-party-file back pointer, while a part of the logical ULRO, is resident in the third-party-file, and is there to facilitate the two-way traversal between data items. As with the number of third-party-file pointers above, the total number of third-party-file back-pointers 218 associated with a particular location 220 will typically be at least equal to the number of third-party-files 274 comprising the location, but since some third-party-files may provide two or more associations, the total number will often be greater by that number of additional associations. Each third-party-file back-pointer 218 may further comprise one or more of the following: a time of creation 295 of the third-party-file back-pointer, information identifying a type 296, and class 297 of the third-party-file back-pointer, and other third-party-file back-pointer information 298.

The embodiment shown in FIG. 2 also includes a metadata field 216 comprising one or more of the following: a ULRO classification 282, a time of creation 284 of the ULRO, a type 285 and class 286 of the ULRO, and other metadata information 287. In accordance with an embodiment, the metadata information can be used to create hierarchical links between the ULROs.

In accordance with other embodiments, other types of location-referencing systems can be used in addition to, or instead of those described above, including, for example, coordinate references that are compliant with ISO Standard 17572-3, Intelligent Transport System (ITS), Location Referencing for Geographic Databases, Part 3: Dynamic Location References, (AGORA-C). Such AGORA-compliant, and AGORA-like alternatives, can be used to populate some or all of the information shown at boxes 206, 207 and 209, including, for example, a name information, coordinate information, and/or file-of-reference pointer information.

ULRO with Offset Pointers

In some instances, the position of the third-party information does not necessarily coincide with the position of a feature in the file-of-reference or digital map database. A relative position with respect to the position of an object in the file-of-reference can be determined and added to the location reference. There are different ways to express the relative position. For example, the relative position of the third-party information with respect to a feature in the file-of-reference can be expressed by adding a distance and an angle to the location reference. Alternatively, the relative position can be expressed by providing two distances, wherein the first distance indicates the relative position of the third-party information with respect to a map object, say to the north, and the second distance indicates the relative position of the third-party information with respect to a map object, say to the east. Another alternative, if the reference map object is one or more line features, e.g. road element(s), and the complete location reference does completely overlap but is only a subset of the map object(s), then the relative position can be expressed as a start offset from the start node of the first map object and an end offset from the start node of the last map object. A plurality of offsets can be combined, for example by combining a distance and an angle from a first location to a second location, together with a distance and an angle from the second location to a third location; or by any other combination of one or more of the above techniques. The use of a plurality of offsets to define the relative position of a location can be useful in defining relative positions and optimal directions that are not merely straight “as the crow flies” directions, for example because the straight direction is blocked by a building or a lake, or is simply not optimal for some reason. These and other examples of relative or offset location expression are further described in copending International Patent Application “METHOD FOR GENERATING A LOCATION REFERENCE AND METHOD FOR MAPPING INFORMATION TO A POSITION WITHIN A DIGITAL MAP DATABASE”, Application Number PCT/NL2006/050185, filed Jul. 21, 2006, and herein incorporated by reference.

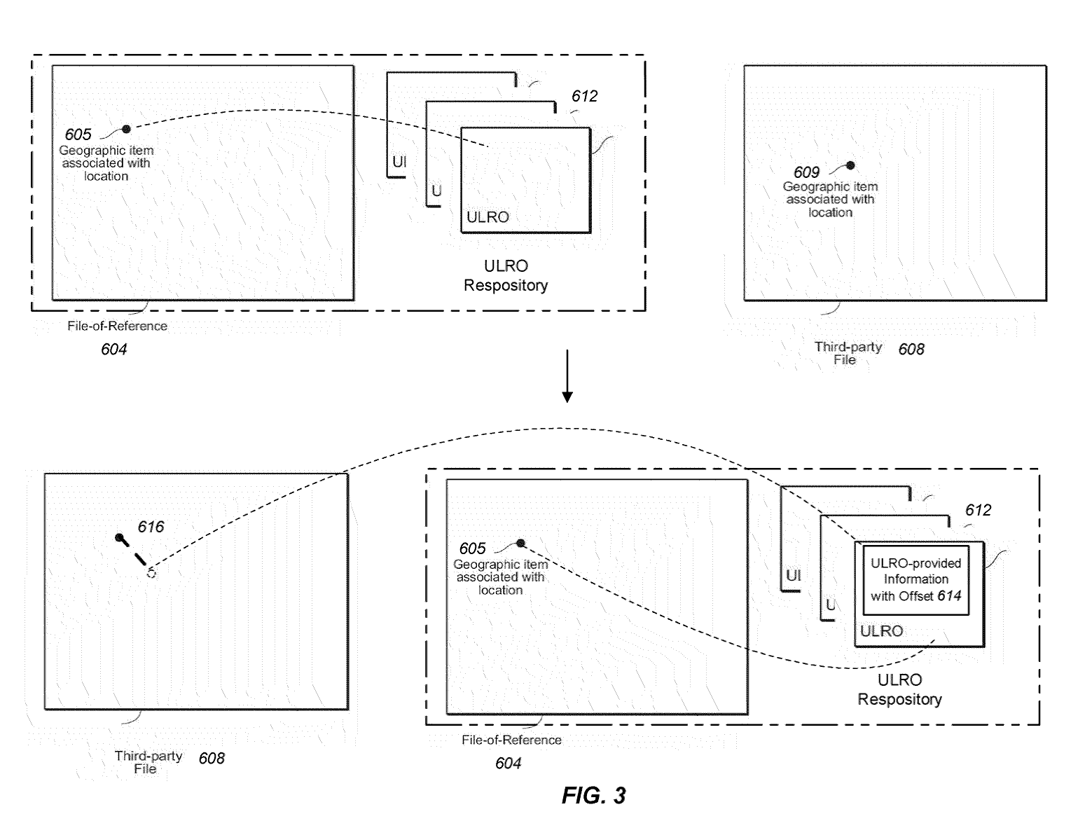

FIG. 3 is an illustration of a system for using ULRO with offset pointers, in accordance with an embodiment. Offset pointer addressing can allow the system to provide information for locations for which either no current object exists in the file-of-reference, or, as described above, the position of the third-party information does not coincide with the position of a feature in the file-of-reference or digital map database. In accordance with an embodiment, instead of specifying a pointer to the geographic item in the file-of-reference or the third-party-file, the system can specify a pointer to another geographic item in the file, together with an appropriate offset, using any of the techniques described above. For example, the offset pointer information can be included in the file-of-reference forward pointer 213 described above.

As shown in FIG. 3, in accordance with an embodiment, the calculation of offsets can be performed on an ongoing basis as a background process, as a one-time batched or periodic process, in a dynamic real-time fashion to respond to a request, or by either the digital map provider or one or more third-party data providers pushing and/or pulling map information from one party to another so as to share the data. In accordance with other embodiments, a request for geographic information can be initially received by the system, and the offset calculation performed in response to that request. In some instances, a file-of-reference 604 can include a known geographic location 605 for a geographic feature, which it can record in a ULRO 612. One or more third-party-files 608 may have information 609 that can be related to the geographic location 605, but for which either no object currently exists in the file-of-reference, or the geographic location of the object in the third-party-file does not coincide with the geographic location of the object in the file-of-reference. In accordance with an embodiment, when the system provides the information from the third-party-file, it can specify a pointer to the original geographic item 605 in the file-of-reference, and then provide an appropriate offset 616 by which the third-party information can be related. This offset pointer can then be included in the forward pointer of the ULRO to the file-of-reference to create (either persistently or transiently as in the case of a virtual database) a ULRO-provided information that includes the offset information 614. This collection of information can then be stored for subsequent use, or in those embodiments that are request-driven provided as a result to the original request.

The above labels of file-of-reference and third-party files are descriptive labels more than anything else, since in other embodiments any of the data files or data sources can act as the file-of-reference, treating the other data files as the third-party-files. In particular, in embodiments that use offset pointers, the ULRO can be used to point to objects, features, and other information that may not be found in any file-of-reference, but can be more appropriately expressed as an offset to a feature located in one of the third-party-files.

An example of such a usage might be a bus-stop, which often would not be specified as its own location in a base map. When relative offset is used, the bus-stop's location on a particular street can be referenced by an offset from a nearby restaurant or other landmark location on that street. Such information about the bus-stop can be provided by a third-party, such as a transportation authority, or by the restaurant, or by any other third-party that has an interest in providing information about bus-stops, but who may not have the ability to incorporate that information into the base map directly. Instead, the offset information can be incorporated into the ULRO using the above technique, so that, when the base map is used to find a bus-stop, the bus-stop information can be incorporated into the result.

ULRO with Interchangeable File-Of-Reference and Third-Party-Files

Generally, the file-of-reference is provided by a digital map provider, a commercial, governmental, or other entity or company which develops, maintains, and provides a file-of-reference or a digital base map; while the third-party-files are provided by a third-party commercial or other entity, which is usually separate from the digital map provider, and which retains control over the particular data in their file. The file-of-reference and third-party-files can be geospatial databases, data structures, documents, or digital maps. Again, these labels are descriptive more than anything else, since in other embodiments any of the data files or data sources can act as the file-of-reference or as the third-party-files.

In some embodiments, a virtual database is a means of treating data distributed over the file-of-reference and third-party-files as if those data sets belonged to a single database. Any system that provides a virtual database in this manner can then properly be referred to as a virtual database system. In accordance with an embodiment the virtual database can be allowed to persist for the life of a user session. The virtual database is one of the applications of ULRO described in copending application “SYSTEM AND METHOD FOR PROVIDING A VIRTUAL DATABASE ENVIRONMENT AND GENERATING DIGITAL MAP INFORMATION”, application Ser. No. 11/742,937, filed May 1, 2007, and herein incorporated by reference.

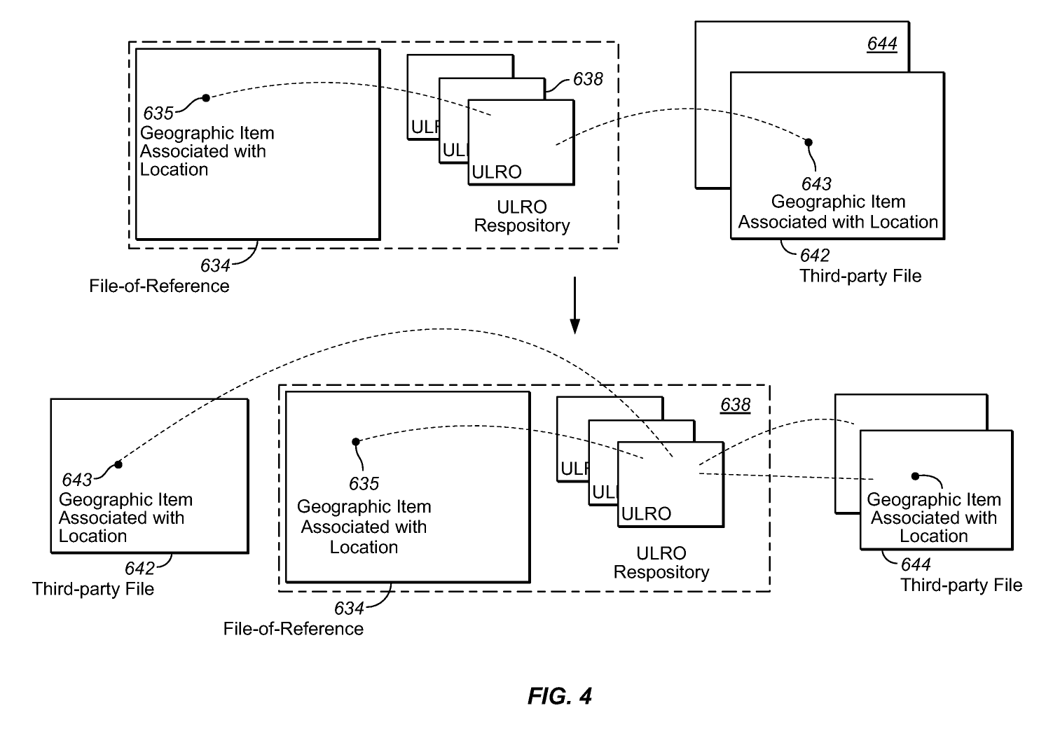

FIG. 4 is an illustration of a system for using ULRO with interchangeable file-of-reference and third-party-files, in accordance with an embodiment. Depending on the embodiment, the sharing of data between the file-of-reference and the third-party-files can be performed on an ongoing basis as a background process, as a one-time batched or periodic process, in a dynamic real-time fashion to respond to a request, or by either the digital map provider or one or more third-party data providers pushing and/or pulling map information from one party to another so as to share the data. Generally, the sharing of information is more efficiently handled as a series of scheduled updates, which can be performed at less busy times, rather than on a per-request basis, and can be initiated either by the system that is hosting the file-of-reference, or, as described in further detail below, by any of the other third-party systems that provide access to the ULRO. In those embodiments that are request-driven, a system that receives the request can act as the file-of-reference, including providing access to ULRO, and collecting geographic information from other parties to best respond to the request.

As shown in FIG. 4, a file-of-reference 634 may include a known geographic location 635 for a geographic feature; while one or more third-party-files 642, 644 may have information that can be related to the geographic location 643 and which can be used to provide a resultant information, or in those embodiments that are request-driven respond to the request. A ULRO 638 together with its associated pointers, and corresponding to a selected geographic item associated with a location in a file-of-reference, allows for mapping of the location-related information between the file-of-reference and one or more of the third-party-files. In accordance with an embodiment, the system allows one of the third-party files 642 to act as the file-of-reference, treating the data from other systems as the third-party-files. In accordance with this embodiment, the file-of-reference and third-party pointers in ULRO 638 corresponding to one or more selected geographic item associated with a location in a file-of-reference are modified, so that the “world” of location information is provided from the perspective of the third-party file 642, including linking location information from third-party file 642 with the file-of-reference and with the other third-party files 644.

As described above, the modification of ULRO pointer information can be performed on an ongoing basis as a background process, or to respond to a request. In accordance with other embodiments, a request for geographic information can be initially received by the system, and the ULRO modification is performed in response to that request.

In accordance with an embodiment, the ULRO information can be alternately viewed from the perspective of each third-party in a strobe-like fashion, to provide a universal means of locating geographic location information.

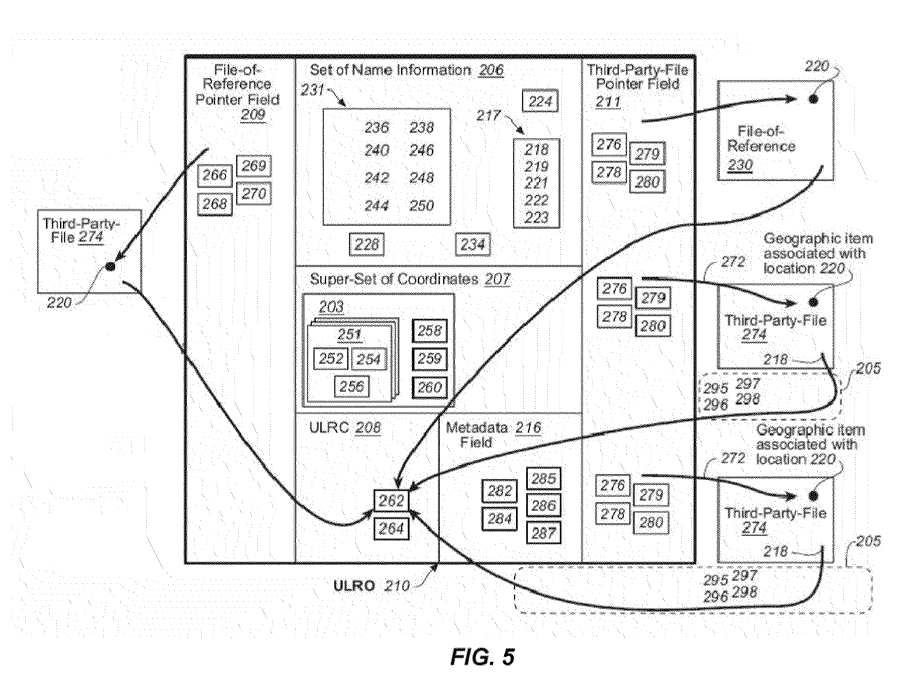

FIG. 5 is another illustration of a system for using ULRO with interchangeable file-of-reference and third-party-files, showing how the ULRO is modified, in accordance with an embodiment. As shown in FIG. 5, when compared to the ULRO previously shown in FIG. 2, when interchangeable files are used the ULRO pointers can be modified so that the file-of-reference pointer field 209 instead includes a pointer to the third-party file 274, while the third-pointer field can be modified so that it includes a pointer to the original file-of-reference.

ULRO with Cascading of ULRO Information

In accordance with an embodiment, each party can maintain its own ULRO pattern, which defines that particular party's understanding of ULRO pointers and the geographic item information linked thereto. Pointers can be interpreted by a third-party to map to a different ULRO pattern. In some instances a third-party can maintain its own repository of ULRO that are private or otherwise not directly accessible by the other third-parties. This linkage can be continued indefinitely over many third-parties in a domino-like or cascading manner. The different ULRO can be traversed, again in a cascading manner, taking into account the different ULRO patterns, and any access rights that may have been applied to private ULRO, to share information between the ULRO and the third-parties. This feature can also be used in a VDB environment to provide for more universal provisioning of data in real-time across many third-parties, and many disparate data sources that use a different data format.

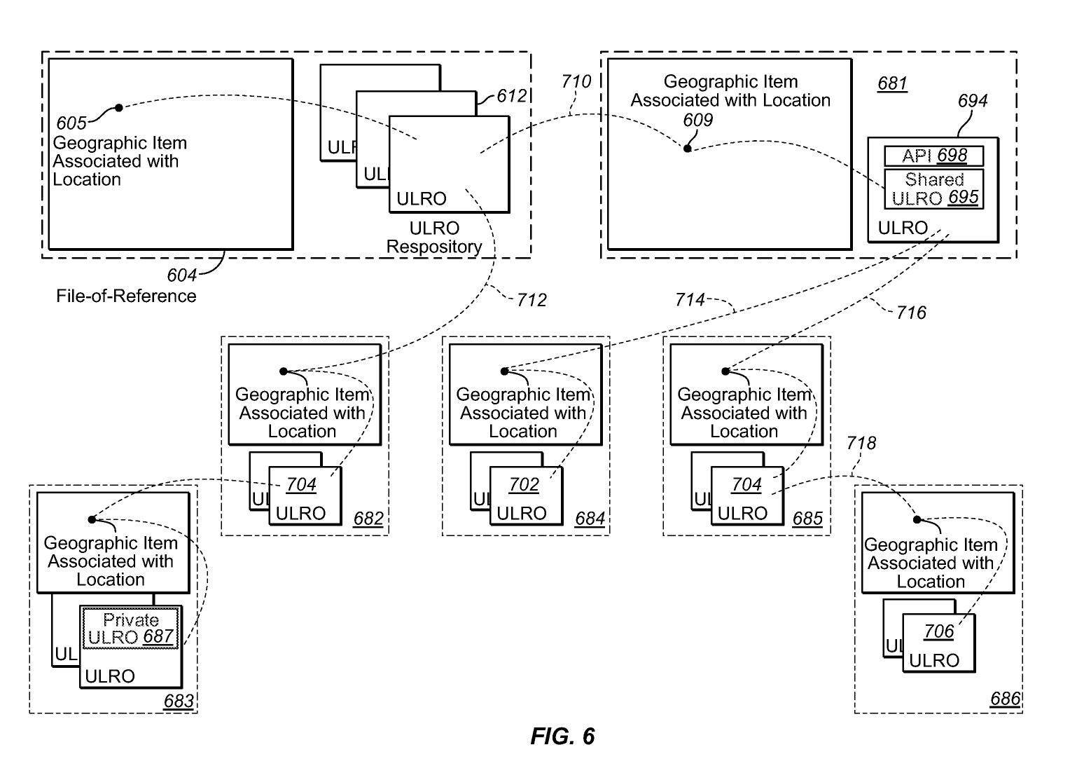

FIG. 6 is an illustration of a system for using ULRO with cascading of ULRO information, in accordance with an embodiment. As shown in FIG. 6, one or more of the third-party-files 681, 682, 683, 684, 685, 686 can each be associated with their own ULRO. In some instances, a party can include ULRO information that is private 687 to that third-party 683. Such private ULRO information can be used by the third-party for their own, internal or proprietary purposes, but is generally not available by that third-party to others for use in responding to requests. Other third-party-files 681 can include ULRO information that is publically shared 695, generally through the use of an application program interface (API) 698. Such public ULRO information can be used by the third-party for their own internal or proprietary purposes; and can also be made available to other third-parties for their use.

In accordance with an embodiment, when the system prepares information the system can automatically use the original ULRO to associate information from different file-of-references and third-party-files. The system can also use the accessible ULRO of those third-parties to retrieve information from yet more third-party-files, in a cascade fashion, including “child” ULRO 702, 704, and “grandchildren” ULRO 706 (as illustrated by the dotted lines 710, 712, 714, 716, 718 in FIG. 6, which illustrates an enterprise-level perspective of the accessibility of data from different third-parties).

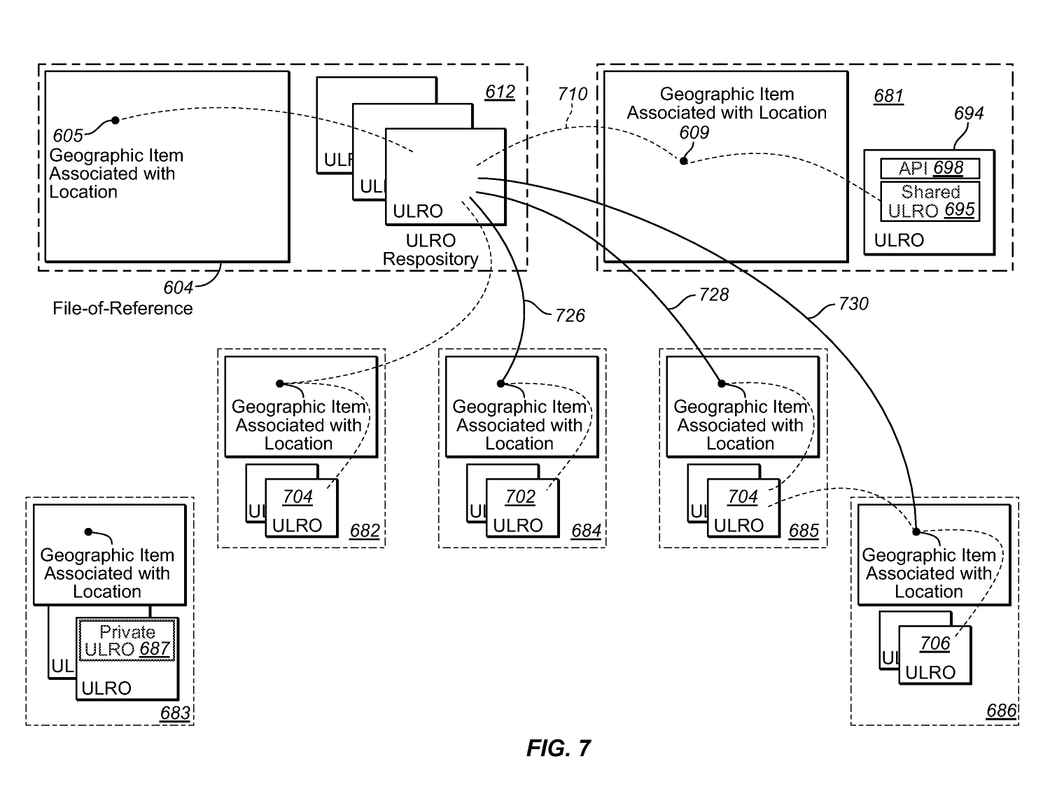

FIG. 7 is another illustration of a system for using ULRO with cascading of ULRO information, showing the result of cascading in accordance with an embodiment, and from the perspective of the file-of-reference. The modification of ULRO pointer information can be performed on an ongoing basis as a background process, as a one-time batched or periodic process, in a dynamic real-time fashion to respond to a request, or by either the digital map provider or one or more third-party data providers pushing and/or pulling map information from one party to another so as to share the data. The net result is that, from the perspective of the file-of-reference 604, the ULRO 612 is populated 726, 728, 730 with information from, or pointers to, each other ULRO source that has been made available. Private ULRO information 687 is not available, and is not incorporated into the cascading. Information about children and grandchildren ULRO (or successive descendants of ULRO) that have been determined by cascading can be supplemented and/or replaced with information, links, or pointers directly to the location information represented by those ULRO, bypassing any intermediate third-parties (as illustrated by the solid lines 726, 728, 730 in FIG. 7).

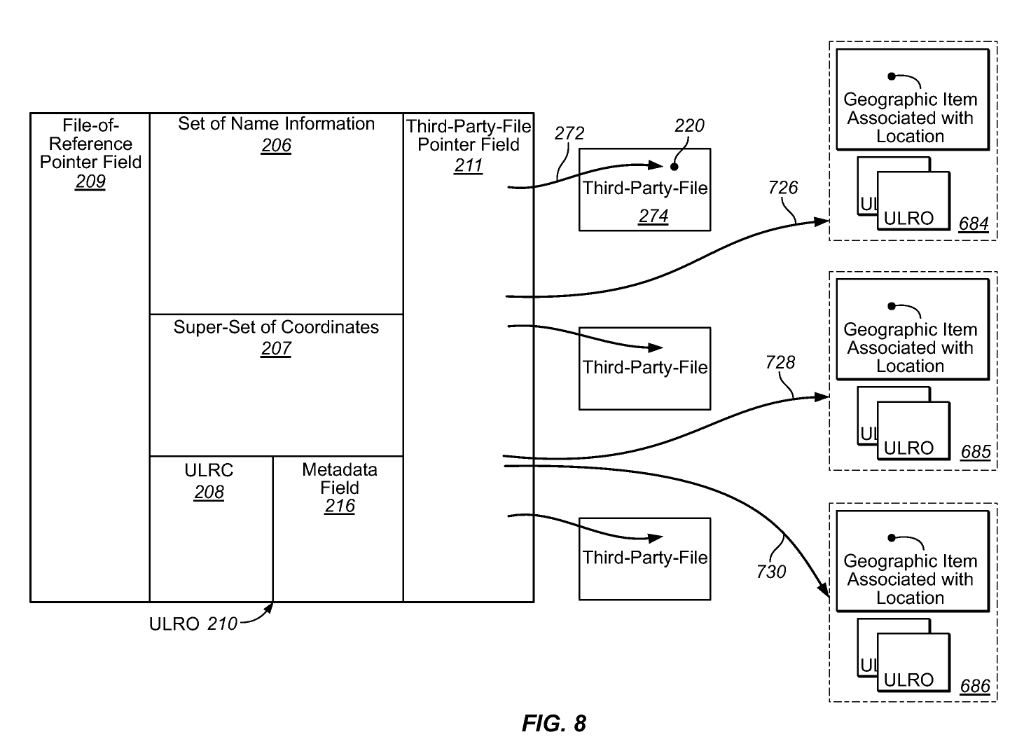

FIG. 8 is an illustration of a system for using ULRO with cascading of ULRO information, showing how the ULRO is modified, in accordance with an embodiment. As shown in FIG. 8, when compared to the ULRO previously shown in FIG. 2, when cascading is used the ULRO pointers can be modified so that the third-pointer file pointer field 211 can be modified so that it includes additional pointers 726, 728, 730 to the additional available ULRO information determined by cascading.

### System Implementation

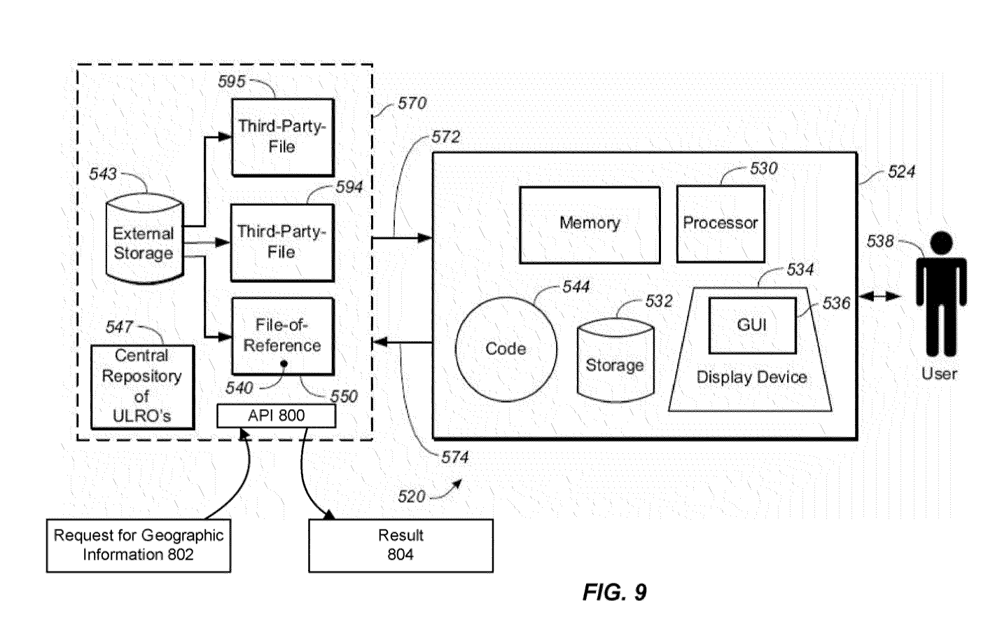

FIG. 9 is a diagram that schematically illustrates an example of a system that can be used with an embodiment. As shown in FIG. 9, the system 520 allows for a ULRO to be created based on geographic item that is associated with a location 540 contained in an electronic file-of-reference 550, and that also has one or more location-associated geographic items contained in one or a plurality third-party-files 594, 595. Although this figure depicts components as logically separate, such depiction is merely for illustrative purposes. It will be apparent to those skilled in the art that the components portrayed in this figure can be combined into a single component, or can be divided into further separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

The system 520 typically includes a computing device 524 which may comprise one or more memories 528, one or more processors 530, and one or more storages or repositories 532 of some sort. The system 520 may further include a display device 534, including a graphical user interface or GUI 536 operating thereon by which the system can display digital maps and other information. The device may under some other circumstances be text-based and/or voice-based.

The system shown herein can be used to display the contents of the electronic document to an operator 538, or automatically to a computer process running on processor 530. Because the software for assigning ULROs will typically be proprietary, hard coding 544 can be used or embedded within the logic of the system to generate ULROs. When all or part of an electronic file-of-reference 550 is retrieved from external storage 553, (which in some instances may be the same storage as storage 532), ULROs and/or ULRCs will be created if they were not previously created (or alternatively will be fetched from a central repository 547 if they had been previously created) to correspond to a geographic item that is associated with a location 540 comprised in the electronic file-of-reference 550. The newly created, or retrieved ULRO is used to link the geographic item in the file-of-reference with location-associated information in the third-party-files. In some cases side files comprising third-party pointers may also be used. As described above, a feature of the system 520 is its ability to facilitate links with locations and location associated geographic items in a wide variety of present and future document formats. Those ULROs can be created by various schemas. One such schema is to generate a ULRO whenever a need arises (such as request by a third-party based on its data needs). Another schema of generating ULROs is to preemptively create ULROs based on all addresses and location objects in the file-of-reference. Hybrid and other schema regimes are possible and conceivable.

Although shown as a single system in FIG. 9, several of the components can be distributed over a variety of different computer systems and processors. For example, in accordance with one embodiment, the user's computer can communicate 572, 574 with a remote server 570 on which all of the database, file-of-reference, third-party-files, and other components are located. However, in other embodiments, for example, the file-of-reference may be located on a different machine from the third-party-files, while the ULRO repository exists on yet another machine. Indeed, it is a feature of the present system that the ULRO allows for information to be dynamically linked from a variety of different sources, including different vendors, even if those sources are widely distributed over a large area, or a large area network, such as the Internet.

As described above, depending on the embodiment, the sharing of data between the file-of-reference and the third-party-files can be performed on an ongoing basis as a background process, as a one-time batched or periodic process, in a dynamic real-time fashion to respond to a request, or by either the digital map provider or one or more third-party data providers pushing and/or pulling map information from one party to another so as to share the data. In those embodiments that are request-driven, the request 802 can be received and a response provided 804, via an application program interface (API) 800 either by the system that is hosting the file-of-reference, or by any of the other third-party systems that provide access to the ULRO.

Embodiments of the present invention may be conveniently implemented using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure, as will be apparent to those skilled in the software art. Embodiments of the invention may also be implemented by the preparation of application specific integrated circuits or by interconnecting an appropriate network of conventional component circuits, as will be readily apparent to those skilled in the art.

Embodiments of the present invention include a computer program product which is a storage medium (media) having instructions stored thereon/in which can be used to program a computer to perform any of the processes of embodiments of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), embodiments of the present invention include software for controlling both the hardware of the general purpose/specialized computer or microprocessor, and for enabling the computer or microprocessor to interact with a human user or other mechanism utilizing the results of embodiments of the present invention. Such software may include, but is not limited to, device drivers, operating systems, and user applications. Ultimately, such computer readable media further includes software for performing embodiments of the present invention, as described above.

Included in the programming (software) of the general/specialized computer or microprocessor are software modules for implementing the teachings of the present invention.

The foregoing description of the present invention has been provided for the purposes of illustration and description. It is not intended to be exhaustive or to limit embodiments of the invention to the precise forms disclosed. Many modifications and variations will be apparent to the practitioner skilled in the art. For example, in accordance with other embodiments, the request-driven functionality described above may be initiated not by a user request, but dynamically or upon request of the system itself, as part of an automatic process of generating information by the system, such as weather or security-related information. Additionally, while the above description generally describes the use of point-based offsets, in accordance with other embodiments, offsets can be line-based, area-based, or based on other types of geographic features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

What is claimed is:

1. A system that uses universal location referencing objects to provide geographic item information for a location, comprising:
an interface to a file-of-reference that comprises geographic item information, including a geographic item associated with a location;
an interface to a third-party-file A that comprises additional geographic item information that may be associated with the location;
an interface to a third-party-file B that comprises additional geographic item information that may be associated with the location;
a first universal location reference object that includes (a) a universal location reference code that uniquely identifies the location, (b) identifying information for the location, and (c) links to the additional geographic item information in the third-party-file A;
a second universal location reference object that includes (a) a universal location reference code that uniquely identifies the location, (b) identifying information for the location, and (c) links both to the additional geographic item information in the third-party-file A and the additional geographic item information in the third-party-file B; and
a logic that retrieves a universal location reference object for the particular location, traverses the links, including cascading the links to the additional geographic item information in the third-party-file A, and the additional geographic item information in the third-party-file B, associates the additional geographic item information in the third-party-file with the geographic item information in the file-of-reference, and provides the resultant information.

2. The system of claim 1, wherein the system includes a search means for receiving a request from the user.

3. The system of claim 2, wherein the system retrieves the universal location reference object for the particular location, traverses the links, including cascading the links to the additional geographic item information in the third-party-file, and the additional geographic item information in the third-party-file, and associates the additional geographic item information in the third-party-file with the geographic item information in the file-of-reference, upon receiving the request from the user, and wherein the resultant information is then provided as a response to the request.

4. A system that uses universal location referencing objects to provide geographic information, for a location, comprising:
a universal location reference object that includes (a) a universal location reference code that uniquely identifies the location, (b) identifying information for the location, and (c) links to additional geographic item information;
a logic for referencing geographic information either by a system that is hosting a file-of-reference, or by any of other third-party-file systems that provide access to the ULRO; and
wherein if the referencing is performed by a system hosting one of the third-party files, then that system can act as the file-of-reference, treating the data from other systems as the third-party-files, and wherein the same ULRO together with its associated pointers, and corresponding to a selected geographic item associated with a location in a file-of-reference, allows for mapping of the location-related information between the different files.

5. The system of claim 4, wherein the system includes a search means for receiving a request from the user.

6. The system of claim 5, wherein the system provides the referencing of geographic information either by the system that is hosting the file-of-reference, or by any of other third-party-file systems that provide access to the ULRO information, upon receiving the request from the user, and wherein the information is then provided as a response to the request.

7. A system that uses universal location referencing objects to provide geographic information, for a location, comprising:
a universal location reference object that includes (a) a universal location reference code that uniquely identifies the location, (b) identifying information for the location, and (c) links to additional geographic item information;
an interface for receiving a request for geographic information;
wherein one or more of the third-party-files include information that can be related to the geographic location, but for which either no object currently exists in the file-of-reference, or the geographic location of the object in the third-party-file does not coincide with the geographic location of the object in the file-of-reference; and
wherein the system provides the information from the third-party-file, by specifying a pointer to the original geographic item in the file-of-reference, and then providing an appropriate offset by which the third-party information can be related, so that the collection of information can then be provided.

8. The system of claim 7, wherein the system includes a search means for receiving a request from the user.

9. The system of claim 8, wherein the system provides the information from the third-party-file including specifying a pointer to the original geographic item in the file-of-reference, and providing an appropriate offset by which the third-party information can be related, upon receiving the request from the user, and wherein the collection of information is then provided as a response to the request.
